(19) United States
(12) Patent Application Publication
(10) Pub. No.: US 2026/0215982 A1
(43) Pub. Date: Jul. 30, 2026

(54) STANDING AID DEVICE

(71) Applicant: Zhejiang Mateside Medical Devices Technology Co., Ltd., Hangzhou (CN)

(72) Inventors: Zhikuo Liu, Hangzhou (CN); Shikun Tian, Hangzhou (CN); Yongliang Hu, Hangzhou (CN); Rui Wang, Hangzhou (CN); Ming Lu, Hangzhou (CN); Tengxuan Zhang, Hangzhou (CN); Juntao Li, Hangzhou (CN); Haonan Lan, Hangzhou (CN); Rui Gao, Hangzhou (CN); Jiajia Wang, Hangzhou (CN); Tingyu Lou, Hangzhou (CN)

(21) Appl. No.: 19/449,459

(22) Filed: Jan. 15, 2026

(30) Foreign Application Priority Data
Jan. 24, 2025 (CN) 202510115729.1

(51) Int. Cl. A61G 5/14

(52) U.S. Cl. CPC A61G 5/14

(57) ABSTRACT

The present disclosure provides a standing aid device, which relates to a technical field of medical care instruments. The standing aid device specifically includes a base assembly, a driving mechanism and a linkage assembly. The base assembly includes a base and a pushing member. The driving mechanism is arranged at one end inside the base. The linkage assembly is arranged in the base and includes a guide member, a first push rod and a second push rod. In use, a patient can sit on the pushing member, the guide member is pushed by the drive motor. The guide member rotates upward during the pushing process, and activates an end of the second push rod to move upward during the rotating process.

### CROSS REFERENCE TO RELATED APPLICATION

The present disclosure claims the priority to the Chinese patent application with the filing No. 2025101157291 filed with the China National Intellectual Property Administration on January 24, 2025, and entitled “STANDING AID DEVICE”, which is incorporated herein by reference in entirety.

### TECHNICAL FIELD

The present disclosure relates to the technical field of medical care instruments, in particular to a standing aid device.

### BACKGROUND

A standing aid device is a device used to assist users with mobility difficulties or insufficient physical strength in transitioning from a sitting or lying posture to a standing posture. This type of assistive device is widely used in the lives of the elderly, rehabilitation patients, and persons with disabilities, aiming to improve their quality of life and independence.

The standing aid device is intended to help people with weak legs and feet to stand, so the product needs to be placed on seating furniture such as sofas or stools. It is usually made of sturdy metal or composite material and designed into a stable frame structure to ensure user safety during use. Furthermore, to facilitate storage and transportation, most standing aid devices are designed as foldable structures, which are deployed when in use and folded for storage when not in use.

Since the standing aid device needs to be placed on seating furniture such as sofas or stools, it is necessary to control the thickness of the standing aid device, and a thinner device is more convenient to use. However, in the prior art, electric push rods are mostly used as driving components to push and assist standing up. When the thickness of the folding support structure is reduced to a certain size, it is prone to causing an excessively small starting angle, making it unable to lift, and the folding structure has a relatively large thickness, making its use inconvenient.

### SUMMARY

An objective of the present disclosure is to provide a standing aid device, so as to alleviate the technical problem in the prior art that when the thickness of the folding support structure is reduced to a certain size, it is prone to causing an excessively small starting angle, making it unable to lift, and the folding structure has a relatively large thickness, making its use inconvenient.

The present disclosure provides a standing aid device, including: a base assembly, a driving mechanism, and a linkage assembly; wherein the base assembly includes a base and a pushing member, and the pushing member is arranged above the base in a manner that the pushing member is capable of covering the base; the driving mechanism is arranged at one end inside the base, and a driving end of the driving mechanism is movable in a horizontal direction towards another end inside the base; the linkage assembly is arranged between the base and the pushing member, the linkage assembly includes a guide member, a first push rod and a second push rod, one end of the guide member is a connecting end and is hinged to the driving end of the driving mechanism, the driving mechanism pushes the guide member to move, causing another end of the guide member to swing upward, the first push rod has a first end and a second end, the first end is provided with a bent portion, the bent portion is obliquely upward and extends away from a direction of the second end, the bent portion is hinged to the guide member, the second end is hinged to a bottom surface of the pushing member, the second push rod and the first push rod are arranged crosswise and are hinged at an intersection thereof, one end of the second push rod is slidably engaged with the pushing member, and another end of the second push rod is hinged to the base; when the driving mechanism is in a retracted state, the guide member is located at a first position, and said one end of the second push rod is located on top of the guide member and abuts against a top surface of the guide member; and when the driving mechanism is in an extended state, the guide member is located at a second position, and said one end of the second push rod is separated from the guide member.

Further, the guide member has a first guide portion and a second guide portion; the first guide portion and the second guide portion are sequentially arranged in a direction away from the connecting end, and a position of the first guide portion is always higher than that of the connecting end; the bent portion is hinged to the first guide portion; when the guide member is at the first position, a position of the second guide portion is lower than that of the first guide portion; and when the guide member is at the second position, the position of the second guide portion is higher than that of the first guide portion.

Further, a top portion of an end of the second guide portion adjacent to the first guide portion is provided with a concave structure; and an end of the second push rod abuts against the concave structure.

Further, an included angle between the first guide portion and the second guide portion is a first obtuse angle; and the first obtuse angle is greater than or equal to 135 degrees and less than or equal to 155 degrees.

Further, an end of the second push rod away from the base is provided with a roller; when the guide member is at the first position, the roller abuts against the concave structure; and a top surface of the roller abuts against the bottom surface of the pushing member.

Further, a through groove is provided in the first push rod, and a first avoidance hole penetrating a bottom of the through groove is provided in the through groove; a position of the first avoidance hole corresponds to a position of the guide member; and an end of the guide member away from the connecting segment is a rotating end, and when the guide member is at the first position, the guide member is located in the first avoidance hole.

Further, the rotating end is provided with a limiting portion; the limiting portion is a convex structure extending in a direction away from the connecting end; and when the guide member is at the first position, the limiting portion abuts against the groove bottom of the through groove.

Further, the second end is provided with a connecting seat; a top surface of the connecting seat is connected to the pushing member, and the connecting seat is hinged to the first push rod; and a second avoidance hole is provided on the second push rod, and when the guide member is at the first position, the connecting seat is located in the second avoidance hole.

Further, the standing aid device further includes a limiter; the limiter is arranged on the first push rod, and a second avoidance hole is provided on the second push rod; when the guide member is at the second position, the limiter abuts against the second push rod; and when the guide member is at the first position, the limiter is located in the second avoidance hole.

Further, a third avoidance hole is provided in the second push rod; the third avoidance hole extends along a length direction of the second push rod and penetrates the second push rod in a vertical direction; and the second end is located in the third avoidance hole.

Further, the driving mechanism includes a drive motor, a lead screw assembly and a connecting shaft; wherein the drive motor is arranged at one end of the base; the lead screw assembly includes a screw rod and a moving part, the screw rod is in transmission connection with the drive motor, the moving part is in threaded engagement with the screw rod and is limited by the base, such that the moving part is movable along an extension direction of the screw rod; the connecting shaft is connected to the moving part; and two linkage assemblies are provided, and the connecting ends of the two linkage assemblies are respectively connected to two ends of the connecting shaft.

Further, two handrails are provided, and the two handrails are arranged on the top surface of the pushing member at intervals.

### Beneficial effects

In the standing aid device provided by the present disclosure, the guide member is driven by the driving mechanism to transition from the first position to the second position. During the transition process, the guide member rotates about the connecting end to activate one end of the second push rod to move upward, thereby enabling the second push rod to undergo a larger degree of inclination from a nearly flat state so as to be driven to rotate. Simultaneously, the first push rod rotates under the combined action of the bent portion and the hinged point with the second push rod, and the first push rod moves towards the hinged point between the second push rod and the base, such that the first push rod and the second push rod cooperate to rotate, thereby moving and rotating the pushing member upward to realize the standing aid action. Therefore, when not in use, the second push rod and the first push rod can be in a nearly flat state inside the base, and the folding effect is excellent, which allows the standing aid device of the present disclosure to achieve a smaller thickness when folded. Moreover, during use, the first push rod and the second push rod can be driven to rotate without requiring excessive starting force, thereby driving the pushing member to move to realize the standing aid action, making the installation of the standing aid device more convenient and its use smoother.

### BRIEF DESCRIPTION OF DRAWINGS

To explain the embodiments of the present disclosure or the technical solutions in the prior art more clearly, the drawings required for describing the embodiments or the prior art will be briefly introduced below. Obviously, the drawings in the following description are some embodiments of the present disclosure. For those skilled in the art, other drawings can be obtained based on these drawings without creative effort.

FIG. 1 is a first schematic structural diagram of a standing aid device according to an embodiment of the present disclosure;

FIG. 2 is a second schematic structural diagram of the standing aid device according to an embodiment of the present disclosure;

FIG. 3 is a third schematic structural diagram of the standing aid device according to an embodiment of the present disclosure;

FIG. 4 is a schematic structural diagram of the standing aid device according to an embodiment of the present disclosure when the driving mechanism is in a retracted state;

FIG. 5 is a schematic structural diagram of the standing aid device according to an embodiment of the present disclosure at the beginning of a second stage;

FIG. 6 is a schematic structural diagram of the standing aid device according to an embodiment of the present disclosure when the standing aid device is in a fully extended state; and

FIG. 7 is a schematic structural diagram of a guide member in the standing aid device according to an embodiment of the present disclosure.

### Reference numerals

100, base assembly; 110, base; 120, pushing member; 121, anti-tipping member; 122, guide groove; 130, handrails; 200, driving mechanism; 210, drive motor; 220, lead screw assembly; 300, linkage assembly; 310, guide member; 311, connecting end; 312, first guide portion; 313, second guide portion; 314, rotating end; 315, limiting portion; 320, first push rod; 321, bent portion; 322, through groove; 323, first avoidance hole; 324, limiter; 325, connecting seat; 330, second push rod; 331, roller; 332, second avoidance hole; 333, third avoidance hole; 334, fourth avoidance hole.

### DETAILED DESCRIPTION OF EMBODIMENTS

To make the objectives, technical solutions, and advantages of the embodiments of the present disclosure clearer, the technical solutions in the embodiments of the present disclosure will be described clearly and completely below in combination with the drawings in the embodiments of the present disclosure. Obviously, the described embodiments are a part of the embodiments of the present disclosure, rather than all of them. Generally, components of the embodiments of the present disclosure described and illustrated in the drawings herein can be arranged and designed in various different configurations.

Therefore, the following detailed description of the embodiments of the present disclosure provided in the drawings is not intended to limit the scope claimed the present disclosure, but only represents selected embodiments of the present disclosure. Based on the embodiments of the present disclosure, all other embodiments obtained by those of ordinary skill in the art without creative effort shall fall within the protection scope of the present disclosure.

It should be noted that similar reference numerals and letters indicate similar items in the following drawings. Therefore, once an item is defined in one drawing, it does not need to be further defined and explained in subsequent drawings.

In the description of the present disclosure, it should be noted that the orientation or positional relationship indicated by terms such as “center”, “upper”, “lower”, “left”, “right”, “vertical”, “horizontal”, “inner”, “outer”, etc., is based on the orientation or positional relationship shown in the drawings, or the orientation or positional relationship in which the product of the present disclosure is usually placed when in use, and is only for the convenience of describing the present disclosure and simplifying the description, rather than indicating or implying that the referred device or element must have a specific orientation, be constructed and operated in a specific orientation. Therefore, it should not be construed as limiting the present disclosure. Furthermore, terms such as “first”, “second”, “third”, etc., are used only for distinguishing description and should not be construed as indicating or implying relative importance.

Furthermore, terms such as “horizontal”, “vertical”, etc., do not mean that the components are required to be absolutely horizontal or vertical, but can be slightly inclined. For example, “horizontal” only means that its direction is more horizontal compared to “vertical”, and does not mean that the structure must be completely horizontal, but can be slightly inclined.

In the description of the present disclosure, it should also be noted that, unless otherwise explicitly specified and limited, the terms “arrange”, “mount”, “connect”, and “couple” should be understood broadly. For example, a connection can be a fixed connection, a detachable connection, or an integral connection; it can be a mechanical connection or an electrical connection; it can be a direct connection, an indirect connection through an intermediate medium, or internal communication between two elements. For those of ordinary skill in the art, the specific meanings of the above-mentioned terms in the present disclosure can be understood based on specific circumstances.

The present disclosure will be further described in detail below through specific embodiments and in combination with the drawings.

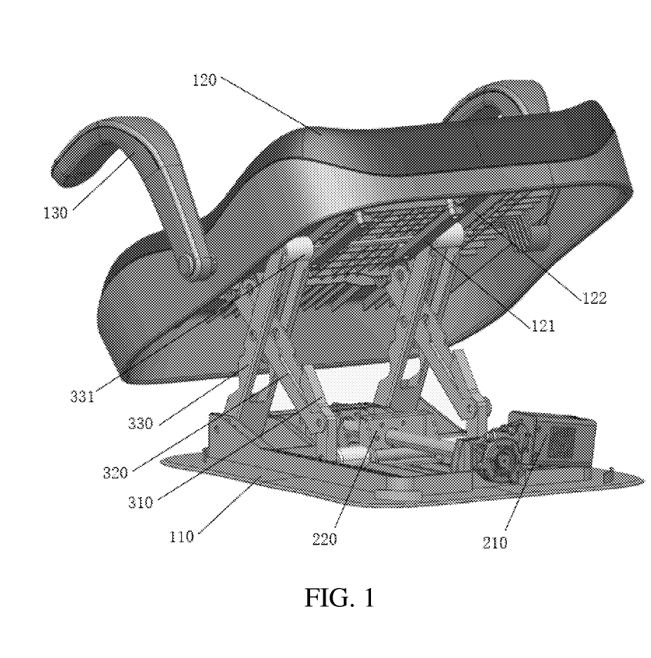

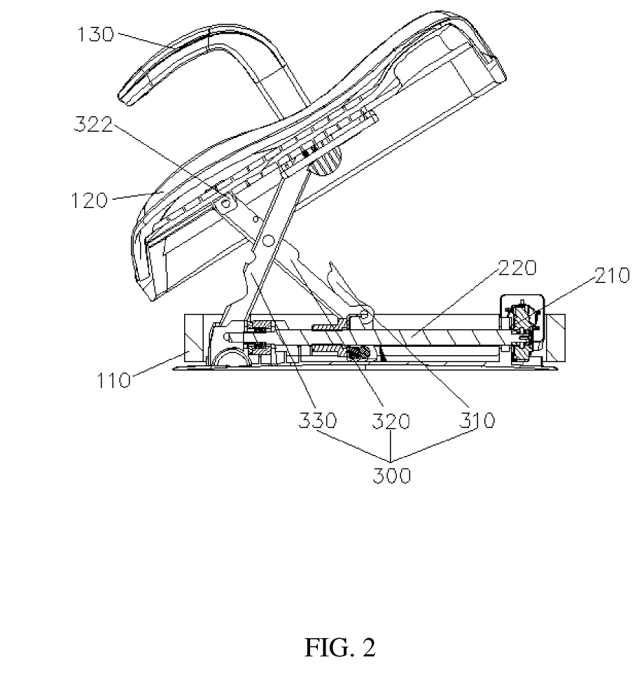

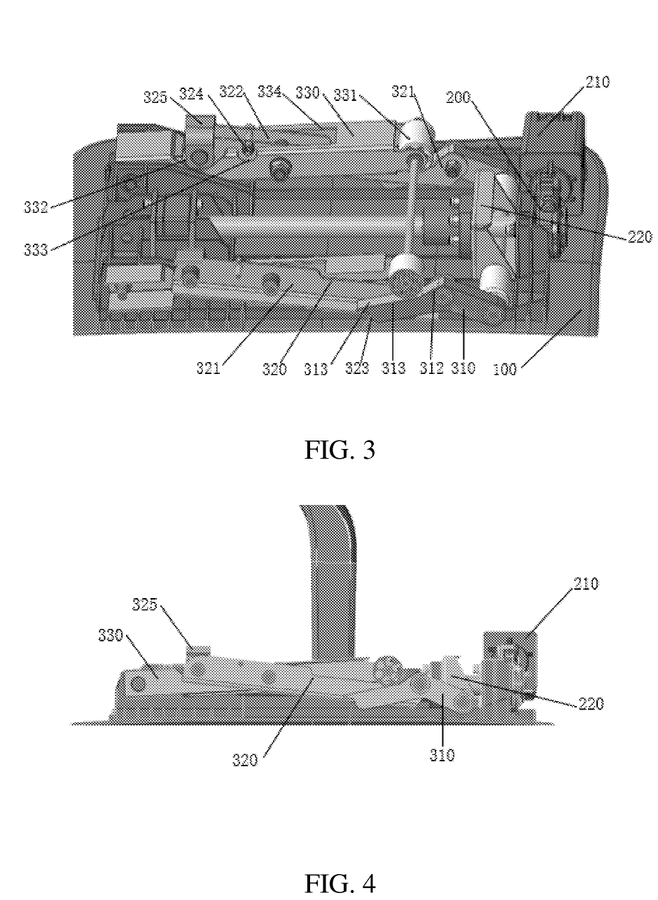

Referring to FIGS. 1 to 3, the standing aid device provided by this embodiment includes a base assembly 100, a driving mechanism 200, and a linkage assembly 300.

The base assembly 100 includes a base 110 and a pushing member 120, and the pushing member 120 is arranged above the base 110 in a manner that the pushing member 120 is capable of covering the base 110. The driving mechanism 200 is arranged at one end inside the base 110, and a driving end of the driving mechanism 200 is movable in a horizontal direction towards another end inside the base 110. The linkage assembly 300 is arranged between the base 110 and the pushing member 120, and includes a guide member 310, a first push rod 320, and a second push rod 330.

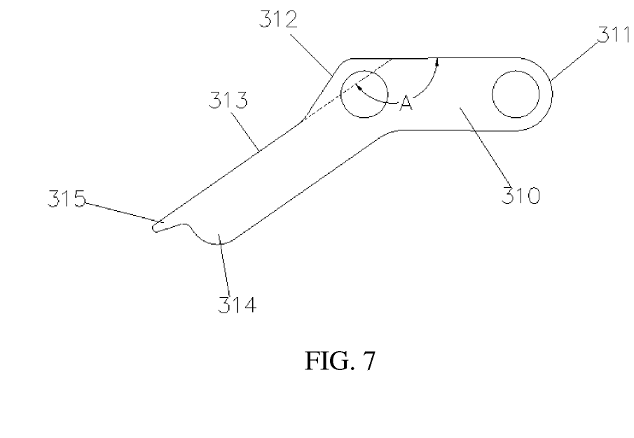

Referring to FIG. 7, one end of the guide member 310 is a connecting end 311 and is hinged to the driving end of the driving mechanism 200. The driving mechanism 200 pushes the guide member 310 to move, causing another end of the guide member 310 to swing upward.

The first push rod 320 has a first end and a second end. The first end is provided with a bent portion 321, which is obliquely upward and extends away from a direction of the second end. The bent portion 321 is hinged to the guide member 310, and the second end is hinged to a bottom surface of the pushing member 120. The second push rod 330 and the first push rod 320 are arranged crosswise and are hinged at an intersection thereof. One end of the second push rod 330 is slidably engaged with the pushing member 120, and another end of the second push rod 330 is hinged to the base 110.

It should be noted that when the driving mechanism 200 is in a retracted state, the guide member 310 is located at a first position, and one end of the second push rod 330 is located on top of the guide member 310 and abuts against a top surface of the guide member 310. When the driving mechanism 200 is in a fully extended state, the guide member 310 is located at a second position, and one end of the second push rod 330 is separated from the guide member 310.

During use, the standing aid device is placed on seating furniture, a patient sits on the pushing member 120, and the driving mechanism 200 is controlled to push the guide member 310. Since the first end of the first push rod 320 is provided with the bent portion 321 extending obliquely upward, the bent portion 321, after being hinged to the guide member 310, generates an upward moment under the push of the driving mechanism 200, thereby driving the guide member 310 to rotate upward during the pushing process through the hinged point between the first push rod 320 and the guide member 310.

During the upward rotation, the guide member 310 actuates an end of the second push rod 330 upward, such that the second push rod 330 changes from a state with a small included angle to the horizontal plane to a state with a larger included angle to the horizontal plane. With the continuous pushing of the driving mechanism 200, the guide member 310 drives the first push rod 320 to move towards the hinged point between the second push rod 330 and the base 110.

During the movement, the second push rod 330 rotates about the hinged point with the base 110 as a rotation axis. The hinged point between the first push rod 320 and the second push rod 330 moves upward, and the intersection point between the first push rod 320 and the guide member 310 also moves slightly upward. The first push rod 320 rotates under the rotation of the second push rod 330 and the guide member 310, causing an end of the first push rod 320 hinged to the pushing member 120 to move upward under the rotation. The first push rod 320 and the second push rod 330 cooperate to rotate, thereby moving and rotating the pushing member 120 upward to realize the standing aid action.

Please refer to FIG. 7 again. In this embodiment, the guide member 310 has a first guide portion 312 and a second guide portion 313. The first guide portion 312 and the second guide portion 313 are sequentially arranged in a direction away from the connecting end 311, and a position of the first guide portion 312 is always higher than the connecting end 311. The bent portion 321 is hinged to the first guide portion 312. When the guide member 310 is at the first position, a position of the second guide portion 313 is lower than that of the first guide portion 312. When the guide member 310 is at the second position, the position of the second guide portion 313 is higher than that of the first guide portion 312.

Specifically, in this embodiment, the first guide portion 312 and the second guide portion 313 are arranged obliquely, and the first guide portion 312 is always located above the second guide portion 313. When the standing aid device is not in use and is placed in a retracted state, the first guide portion 312 is always located above the hinged point between the guide member 310 and the driving end. At this time, the first guide portion 312, the second guide portion 313, and the hinged point between the first guide portion 312 and the driving end form a triangle, with the first guide portion 312 being higher than the second guide portion 313 and the connecting end 311.

In this embodiment, the driving mechanism 200 is arranged at one end of the base 110, and the hinged point between the second push rod 330 and the base 110 is located at an end away from the driving mechanism 200.

With this structure, when the driving end pushes the first guide portion 312 to move, because the first guide portion 312 and the connecting end 311 are arranged obliquely upward, and in cooperation with the obliquely upward bent structure of the bent portion 321, the guide member 310 generates an obliquely upward moment under the push. Moreover, the bent portion 321 applies a reaction force to the guide member 310, enabling the guide member 310 to rotate upward about the hinged point between the first guide portion 312 and the driving end as a rotation axis under the push, thereby realizing the flipping of the guide member 310, and in turn driving the second guide portion 313 to rotate upward together.

The second guide portion 313 actuates the second push rod 330 during the flipping process, causing the second push rod to change from a flat state to an inclined state, and rotates together with the first push rod 320 to drive the pushing member 120 to move, thereby realizing the switching of the first push rod 320 and the second push rod 330 from a flat state to an inclined state.

When the driving mechanism 200 drives the guide member 310 to rotate to its limit, the guide member 310 is at the second position. At this time, the position of the second guide portion 313 is higher than that of the first guide portion 312, the position of the first guide portion 312 is higher than that of the connecting end 311, and the first push rod 320 and the second push rod 330 are arranged obliquely and crosswise. The top ends of the first push rod 320 and the second push rod 330 provide support for the pushing member 120.

As an implementable manner, the driving mechanism 200 can also be arranged at the same end as the hinged point between the second push rod 330 and the base 110. In this structure, the driving mechanism 200 retracts to drive the guide member 310 to rotate, causing the guide member 310 to transition from the first position to the second position.

In this embodiment, the inclined structure formed by the first guide portion 312, the second guide portion 313, and the driving end can form an obliquely upward moment with the first push rod 320, such that when the driving end pushes the guide member 310 in the horizontal direction, the first guide portion 312 and the second guide portion 313 can be flipped upward, thereby realizing the action of switching the first push rod 320 and the second push rod 330 from a flat state to rotating. Consequently, the first push rod 320 and the second push rod 330 can be arranged in a flat manner when not in use to reduce the occupied space and the thickness of the standing aid device, and can be driven smoothly during use to realize standing assistance.

In this embodiment, a top portion of an end of the second guide portion 313 adjacent to the first guide portion 312 is provided with a concave structure. An end of the second push rod 330 abuts against the concave structure.

Specifically, in this embodiment, a connection of the first guide portion 312 and the second guide portion 313 is provided with a low concave structure, such that the end of the second push rod 330 can be accurately positioned in this location. Moreover, the concave structure and the connecting segment of the first guide portion 312 form an upward inclination with a larger angle, which can enhance the guiding capability when activating the second push rod 330 to change the second guide member 310 from a flat state to an inclined state, further ensuring the smoothness of the start-up of the second push rod 330.

Specifically, in this embodiment, as shown in FIG. 7, an included angle between the first guide portion 312 and the second guide portion 313 is a first obtuse angle, i.e., the included angle A in FIG. 7. The angle A is greater than or equal to 135 degrees and less than or equal to 155 degrees.

Here, when the angle A is greater than 155 degrees, it tends to cause the overall thickness of the standing aid device to be relatively thick, adversely affecting the user experience. When the angle A is 155 degrees, the guide member 310 is easier to deflect, and an initial starting force required by a motor is smaller.

When the angle A is less than 135 degrees, the initial starting force required by the motor is greater, the time required for the initial starting state is longer, and the service life of the motor will be reduced. When the angle A is 135°-155°, the thickness of the standing aid device is smaller, and the initial starting force required by the motor is smaller, which is relatively easy to satisfy. Specifically, in this embodiment, the angle A is 145°, the device thickness is moderate, the initial starting force of the motor is small, and effect of use is better.

Specifically, the guide member 310 in this embodiment has a bent structure, a middle portion of the guide member 310 protrudes upward, the middle portion is the first guide portion 312, an end of the first guide portion 312 at a side extends obliquely downward and is hinged to the driving end, and another side of the first guide portion 312 extends obliquely downward to form the second guide portion 313. Under this structure, to ensure that the obliquely upward moment generated by the first guide portion 312 and the driving end can cause the first guide portion 312 and the second guide portion 313 to rotate, a bottom surface of the first guide portion 312 and a bottom surface of the second guide portion 313 form an obtuse angle to ensure force transmission.

In this embodiment, an end of the second push rod 330 away from the base 110 is provided with a roller 331. When the guide member 310 is at the first position, the roller 331 abuts against the concave structure. A top surface of the roller 331 abuts against the bottom surface of the pushing member 120.

Specifically, when the second push rod 330 and the first push rod 320 rotate from a flat state to elevate the pushing member 120, an end of the first push rod 320 is hinged to the bottom surface of the pushing member 120, and the pushing member 120 rotates about the hinged point with the first push rod 320. When an end of the second push rod 330 slides to elevate the pushing member 120, the roller 331 contacts the bottom surface of the pushing member 120, such that during the process of the second push rod 330 elevating the pushing member 120, the roller 331 can push up the pushing member 120 by rolling, realizing the flipping action of the pushing member 120 and reducing friction when the second push rod 330 pushes the pushing member 120.

In this embodiment, a through groove 322 is provided in the first push rod 320, and a first avoidance hole 323 penetrating a groove bottom of the through groove 322 is provided in the through groove 322. A position of the first avoidance hole 323 corresponds to a position of the guide member 310. An end of the guide member 310 away from the connecting segment is a rotating end 314. When the guide member 310 is at the first position, the guide member 310 is located in the first avoidance hole 323.

Here, in this embodiment, to reduce the overall weight of the standing aid device, the first push rod 320 and the second push rod 330 are both hollow structures. When the guide member 310 is at the first position, i.e., the standing aid device is in a folded state and not in use, the guide member 310 can be received in the first avoidance hole 323, thereby reducing the space occupied by the guide member 310 and reducing the overall height and volume of the standing aid device.

As an implementable manner, the guide member 310, the first push rod 320, and the second push rod 330 can be arranged crosswise along a width direction of the pushing member 120 or a width direction of the standing aid device. In this structure, the overall structural strength of the linkage assembly 300 is more excellent, and the standing aid device can bear a larger load.

Specifically, in this embodiment, an end of the guide member 310 away from the connecting end 311 is provided with a limiting portion 315. The limiting portion 315 is a convex structure extending in a horizontal direction. When the guide member 310 is at the first position, the limiting portion 315 abuts against the groove bottom of the through groove 322.

When the guide member 310 is located in the first avoidance hole 323, to prevent the rotation angle of the guide member 310 from being too low, causing the moment formed by the first guide portion 312 and the driving end to be in a horizontal direction, and resulting in the guide member 310 being unable to flip upward smoothly to activate the second push rod 330, in this embodiment, a limiting portion 315 with a convex structure is provided at the end of the guide member 310. When the guide member 310 is received in the first avoidance hole 323, the limiting portion 315 can be rests in the through groove 322, and an end of the limiting portion 315 abuts against the bottom surface of the through groove 322, such that the moment between the first guide portion 312 and the driving end can remain obliquely upward, thereby ensuring that the guide member 310 can smoothly flip upward when pushed by the driving end.

In this embodiment, the second end is provided with a connecting seat 325. A top surface of the connecting seat 325 is connected to the pushing member 120, and the connecting seat 325 is hinged to the first push rod 320. A second avoidance hole 332 is provided on the second push rod 330. When the guide member 310 is at the first position, the connecting seat 325 is located in the second avoidance hole 332.

Similarly, when the guide member 310 is at the first position, i.e., when the standing aid device is idle and not in use, the connecting seat 325 can be received in the second avoidance hole 332, thereby further reducing the overall height of the standing aid device.

In this embodiment, the standing aid device further includes a limiter 324. The limiter 324 is arranged on the first push rod 320, and a third avoidance hole 333 is provided on the second push rod 330. When the guide member 310 is at the second position, the limiter 324 abuts against the second push rod 330, such that rotation angles of the first push rod 320 and the second push rod 330 are less than 90 degrees. When the guide member 310 is at the first position, the limiter 324 is located in the third avoidance hole 333.

Specifically, the limiter 324 in this embodiment is a limit bolt, which is arranged on the first push rod 320 and extends in a horizontal direction. When the first push rod 320 and the second push rod 330 rotate to push the pushing member 120 to move, after the first push rod 320 and the second push rod 330 rotate to an angle, the second push rod 330 abuts against the limit bolt, thereby preventing the pushing member 120 from rotating at an excessively large angle and covering and applying pressure to the user.

Moreover, when the guide member 310 is at the first position, i.e., when the standing aid device is in a folded state and not in use, the limit bolt can be received within the third avoidance hole 333 on the second push rod 330. This prevents the limit bolt from abutting against a top portion of the second push rod 330 when the standing aid device is folded, thereby ensuring that the first push rod 320 can return to a flat state.

In this embodiment, a fourth avoidance hole 334 is provided in the second push rod 330. The fourth avoidance hole 334 extends along a length direction of the second push rod 330 and penetrates the second push rod 330 in a vertical direction. The second end is located in the fourth avoidance hole 334.

Similarly, when the guide member 310 is at the first position, the first push rod 320 can be received in the first avoidance hole 323, such that the first push rod 320 and the second push rod 330 are folded and stowed to further reduce the height of the standing aid device.

Moreover, in the second push rod 330, a limiting groove is provided on one side of the fourth avoidance hole 334. The limiting groove and the first avoidance hole 323 are respectively located on both sides of the hinged point of the first push rod 320 and the second push rod 330. When the first push rod 320 and the second push rod 330 are folded and stowed, a portion of the first push rod 320 is received in the fourth avoidance hole 334, and another portion abuts against a groove bottom of the limiting groove. With this structure, it is possible to prevent the first push rod 320 and the second push rod 330 from reversing due to an excessive rotation angle during folding, thereby ensuring that the first push rod 320 and the second push rod 330 can smoothly move upward and elevate the pushing member 120 when the driving end pushes the guide member 310.

In this embodiment, the driving mechanism 200 includes a drive motor 210, a lead screw assembly 220, and a connecting shaft. The drive motor 210 is arranged at one end of the base 110. The lead screw assembly 220 includes a screw rod and a moving part. The screw rod is in transmission connection with the drive motor 210, and the moving part is in threaded engagement with the screw rod to move along an extension direction of the screw rod. The connecting shaft is connected to the moving part. Two linkage assemblies 300 are provided. The connecting ends 311 of the two linkage assemblies 300 are respectively connected to two ends of the connecting shaft.

As an implementable manner, the driving mechanism 200 can also employ driving elements such as electric cylinders or pneumatic cylinders, and the lead screw assembly 220 can be replaced by a gear-and-rack mechanism or any transmission structure capable of achieving power transmission.

Specifically, in this embodiment, the drive motor 210 rotates the screw rod to move the moving part along the extension direction of the screw rod, and drives the two linkage assemblies 300 to move synchronously via the connecting shaft connected to the moving part, thereby achieving multi-point support and multi-point pushing of the pushing member 120, improving the driving stability of the pushing member 120, and enhancing the structural stability of the standing aid device.

In this embodiment, two handrails 130 are provided. The two handrails 130 are arranged on the top surface of the pushing member 120 at intervals.

Specifically, the handrails 130 in this embodiment have a rotatable and foldable bent structure.

When using the standing aid device provided by this embodiment, the standing aid device can be placed in a retracted state by folding the first push rod 320, the second push rod 330, and the guide member 310. At this time, the guide member 310 is at the first position. The standing aid device is laid flat and the handrails 130 are folded, allowing the user to sit onto the pushing member 120 from a side of the standing aid device.

Subsequently, the drive motor 210 is activated, the standing aid device initiates operation, and the pushing member 120 rises to assist standing.

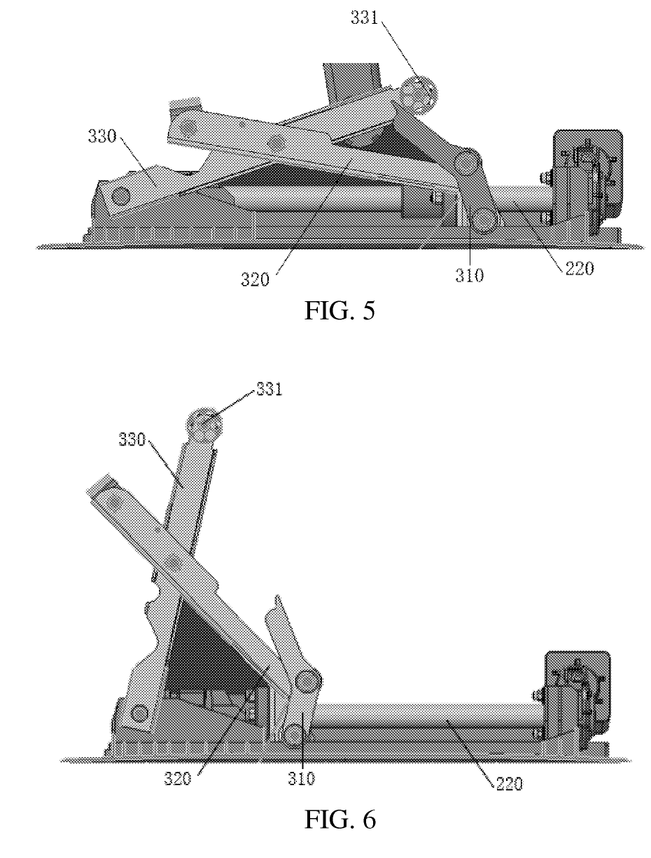

The rise of the pushing member 120 is divided into two stages. Specifically, in the first stage, both the first push rod 320 and the second push rod 330 are in a nearly flat state, and the included angles between the first push rod 320, the second push rod 330 and the horizontal plane are small. Referring to FIG. 4, at this time, the overall thickness of the standing aid device is minimal, making it easy for the user to set up for use. The guide member 310 is pushed by the driving end. Under the pushing of the driving end, the guide member 310 rotates about the connecting end 311, the rotating end 314 swings upward, and the guide member 310 flips. During the flipping process, the roller 331 at the end of the second push rod 330 is activated to move upward. The roller 331 is moved out of the concave structure and is raised to a height under the activation. Referring to FIG. 5, this causes the second push rod 330 to transition from a nearly flat state to a state with a larger included angle to the horizontal plane, thereby reducing the initial driving force required for the standing aid device to transition from the folded state to the deployed state. The second stage begins after the roller 331 rolls and disengages from the guide member 310.

In the second stage, both the first push rod 320 and the second push rod 330 are in an inclined state under the action of the guide member 310. Under the continuous pushing of the driving end, the pushing member 120 rotates about the hinged point with the first push rod 320. The second push rod 330, in cooperation with the roller 331, pushes and elevates another end of the pushing member 120. Referring to FIG. 6, the standing assistance function of the standing aid device is thereby realized.

Furthermore, in this embodiment, the guide member 310, the first push rod 320, and the second push rod 330 achieve an inter-nesting arrangement through the first avoidance hole 323, the second avoidance hole 332, the third avoidance hole 333, and the fourth avoidance hole 334, further reducing the overall thickness of the standing aid device in the folded state, facilitating placement underneath the body of the user when needed.

It should be noted here that, in this embodiment, a surface of the pushing member 120 facing the base 110 is provided with an anti-tipping member 121 and a guide groove 122.

The anti-tipping member 121 in this embodiment has a sliding chute. The sliding chute is arranged parallel to the pushing member 120. A rotation shaft of the roller 331 is inserted into the sliding chute. During the process where the second push rod 330 pushes and elevates another end of the pushing member 120 in cooperation with the roller 331, the rotation shaft slides within the sliding chute. Moreover, when the guide member is at the first position and the second position, the rotation shaft is correspondingly located at the two ends of the sliding chute, respectively. The rotation shaft is always inserted into the sliding chute. With this structure, it can be ensured that the pushing member 120 can only perform rotation under the pushing of the first push rod 320 and the second push rod 330, and will not flip, thereby preventing the pushing member 120 from flipping when the rotation speed is too fast or when the standing aid device is arranged obliquely, which would affect use.

Additionally, the guide groove 122 in this embodiment is adapted to the roller 331. During the process where the second push rod 330 pushes and elevates the pushing member 120 via the roller 331, the roller 331 remains in contact with the guide groove 122, keeping the movement trajectory of the roller 331 as a preset trajectory and preventing deviation of the roller 331 during the movement process.

Finally, it should be noted that the aforementioned embodiments are only used to illustrate the technical solutions of the present disclosure, and not to limit them. Although the present disclosure has been described in detail with reference to the foregoing embodiments, those of ordinary skill in the art should understand that they can still modify the technical solutions described in the foregoing embodiments, or perform equivalent substitutions for some or all of the technical features thereof. However, these modifications or substitutions do not cause the essence of the corresponding technical solutions to depart from the scope of the technical solutions of the embodiments of the present disclosure.

1. A standing aid device, comprising:
a base assembly, a driving mechanism, and a linkage assembly; wherein
the base assembly comprises a base and a pushing member, the pushing member is arranged above the base in a manner that the pushing member is capable of covering the base;
the driving mechanism is arranged in the base, and a driving end of the driving mechanism is movable in a horizontal direction;
the linkage assembly is arranged between the base and the pushing member, and comprises a guide member, a first push rod and a second push rod, wherein one end of the guide member is a connecting end and is hinged to the driving end of the driving mechanism, the driving mechanism pushes the guide member to move, causing another end of the guide member to swing upward, the first push rod has a first end and a second end, the first end is provided with a bent portion which is obliquely upward and extends away from a direction of the second end, the bent portion is hinged to the guide member, the second end is hinged to a bottom surface of the pushing member, the second push rod and the first push rod are arranged crosswise and are hinged at an intersection thereof, one end of the second push rod is slidably engaged with the pushing member, and another end of the second push rod is hinged to the base;
when the driving mechanism is in a retracted state, the guide member is located at a first position, and said one end of the second push rod is located on top of the guide member and abuts against a top surface of the guide member; and
when the driving mechanism is in an extended state, the guide member is located at a second position, and said one end of the second push rod is separated from the guide member.

2. The standing aid device according to claim 1, wherein
the guide member has a first guide portion and a second guide portion;
the first guide portion and the second guide portion are sequentially arranged in a direction away from the connecting end, and a position of the first guide portion is always higher than that of the connecting end;
the bent portion is hinged to the first guide portion;
when the guide member is at the first position, a position of the second guide portion is lower than that of the first guide portion; and
when the guide member is at the second position, the position of the second guide portion is higher than that of the first guide portion.

3. The standing aid device according to claim 2, wherein
a top portion of an end of the second guide portion adjacent to the first guide portion is provided with a concave structure; and
an end of the second push rod abuts against the concave structure.

4. The standing aid device according to claim 3, wherein an included angle between the first guide portion and the second guide portion is a first obtuse angle; and
the first obtuse angle is greater than or equal to 135 degrees and less than or equal to 155 degrees.

5. The standing aid device according to claim 4, wherein
an end of the second push rod away from the base is provided with a roller;
when the guide member is at the first position, the roller abuts against the concave structure; and
a top surface of the roller abuts against the bottom surface of the pushing member.

6. The standing aid device according to claim 2, wherein
a through groove is provided in the first push rod, and a first avoidance hole penetrating a groove bottom of the through groove is provided in the through groove;
a position of the first avoidance hole corresponds to a position of the guide member; and
an end of the guide member away from the connecting end is a rotating end, and when the guide member is at the first position, the guide member is located in the first avoidance hole.

7. The standing aid device according to claim 6, wherein
the rotating end is provided with a limiting portion;
the limiting portion is a convex structure extending in a direction away from the connecting end; and
when the guide member is at the first position, the limiting portion abuts against the groove bottom of the through groove.

8. The standing aid device according to claim 2, wherein
the second end is provided with a connecting seat;
a top surface of the connecting seat is connected to the pushing member, and the connecting seat is hinged to the first push rod; and
a second avoidance hole is provided on the second push rod, and when the guide member is at the first position, the connecting seat is located in the second avoidance hole.

9. The standing aid device according to claim 2, further comprising a limiter, wherein
the limiter is arranged on the first push rod, and a third avoidance hole is provided on the second push rod;
when the guide member is at the second position, the limiter abuts against the second push rod; and
when the guide member is at the first position, the limiter is located in the third avoidance hole.

10. The standing aid device according to claim 1, wherein
a fourth avoidance hole is provided in the second push rod;
the fourth avoidance hole extends along a length direction of the second push rod and penetrates the second push rod in a vertical direction; and
the second end is located in the fourth avoidance hole.

11. The standing aid device according to claim 1, wherein
the driving mechanism comprises a drive motor, a lead screw assembly and a connecting shaft;
the drive motor is arranged at one end of the base;
the lead screw assembly comprises a screw rod and a moving part, the screw rod is in transmission connection with the drive motor, the moving part is in threaded engagement with the screw rod and is limited by the base, such that the moving part is movable along an extension direction of the screw rod;
the connecting shaft is connected to the moving part; and
two linkage assemblies are provided, and the connecting ends of the two linkage assemblies are respectively connected to two ends of the connecting shaft.

12. The standing aid device according to claim 11, wherein
the base assembly further comprises two handrails; and
the two handrails are arranged on a top surface of the pushing member at intervals.

13. The standing aid device according to claim 2, wherein
the driving mechanism comprises a drive motor, a lead screw assembly and a connecting shaft;
the drive motor is arranged at one end of the base;
the lead screw assembly comprises a screw rod and a moving part, the screw rod is in transmission connection with the drive motor, the moving part is in threaded engagement with the screw rod and is limited by the base, such that the moving part is movable along an extension direction of the screw rod;
the connecting shaft is connected to the moving part; and
two linkage assemblies are provided, and the connecting ends of the two linkage assemblies are respectively connected to two ends of the connecting shaft.

14. The standing aid device according to claim 3, wherein
the driving mechanism comprises a drive motor, a lead screw assembly and a connecting shaft;
the drive motor is arranged at one end of the base;
the lead screw assembly comprises a screw rod and a moving part, the screw rod is in transmission connection with the drive motor, the moving part is in threaded engagement with the screw rod and is limited by the base, such that the moving part is movable along an extension direction of the screw rod;
the connecting shaft is connected to the moving part; and
two linkage assemblies are provided, and the connecting ends of the two linkage assemblies are respectively connected to two ends of the connecting shaft.

15. The standing aid device according to claim 4, wherein
the driving mechanism comprises a drive motor, a lead screw assembly and a connecting shaft;
the drive motor is arranged at one end of the base;
the lead screw assembly comprises a screw rod and a moving part, the screw rod is in transmission connection with the drive motor, the moving part is in threaded engagement with the screw rod and is limited by the base, such that the moving part is movable along an extension direction of the screw rod;
the connecting shaft is connected to the moving part; and
two linkage assemblies are provided, and the connecting ends of the two linkage assemblies are respectively connected to two ends of the connecting shaft.

16. The standing aid device according to claim 5, wherein
the driving mechanism comprises a drive motor, a lead screw assembly and a connecting shaft;
the drive motor is arranged at one end of the base;
the lead screw assembly comprises a screw rod and a moving part, the screw rod is in transmission connection with the drive motor, the moving part is in threaded engagement with the screw rod and is limited by the base, such that the moving part is movable along an extension direction of the screw rod;
the connecting shaft is connected to the moving part; and
two linkage assemblies are provided, and the connecting ends of the two linkage assemblies are respectively connected to two ends of the connecting shaft.

17. The standing aid device according to claim 6, wherein
the driving mechanism comprises a drive motor, a lead screw assembly and a connecting shaft;
the drive motor is arranged at one end of the base;
the lead screw assembly comprises a screw rod and a moving part, the screw rod is in transmission connection with the drive motor, the moving part is in threaded engagement with the screw rod and is limited by the base, such that the moving part is movable along an extension direction of the screw rod;
the connecting shaft is connected to the moving part; and
two linkage assemblies are provided, and the connecting ends of the two linkage assemblies are respectively connected to two ends of the connecting shaft.

18. The standing aid device according to claim 7, wherein
the driving mechanism comprises a drive motor, a lead screw assembly and a connecting shaft;
the drive motor is arranged at one end of the base;
the lead screw assembly comprises a screw rod and a moving part, the screw rod is in transmission connection with the drive motor, the moving part is in threaded engagement with the screw rod and is limited by the base, such that the moving part is movable along an extension direction of the screw rod;
the connecting shaft is connected to the moving part; and
two linkage assemblies are provided, and the connecting ends of the two linkage assemblies are respectively connected to two ends of the connecting shaft.

19. The standing aid device according to claim 8, wherein
the driving mechanism comprises a drive motor, a lead screw assembly and a connecting shaft;
the drive motor is arranged at one end of the base;
the lead screw assembly comprises a screw rod and a moving part, the screw rod is in transmission connection with the drive motor, the moving part is in threaded engagement with the screw rod and is limited by the base, such that the moving part is movable along an extension direction of the screw rod;
the connecting shaft is connected to the moving part; and
two linkage assemblies are provided, and the connecting ends of the two linkage assemblies are respectively connected to two ends of the connecting shaft.

20. The standing aid device according to claim 9, wherein
the driving mechanism comprises a drive motor, a lead screw assembly and a connecting shaft;
the drive motor is arranged at one end of the base;
the lead screw assembly comprises a screw rod and a moving part, the screw rod is in transmission connection with the drive motor, the moving part is in threaded engagement with the screw rod and is limited by the base, such that the moving part is movable along an extension direction of the screw rod;
the connecting shaft is connected to the moving part; and
two linkage assemblies are provided, and the connecting ends of the two linkage assemblies are respectively connected to two ends of the connecting shaft.
